(19) United States
(12) Patent Application Publication
(10) Pub. No.: US 2023/0114702 A1
(43) Pub. Date: Apr. 13, 2023

(54) ASSEMBLY METHOD AND DEVICE FOR A ROTOR OF AN ELECTRIC MOTOR, AND KITCHEN APPLIANCE

(71) Applicant: BSH Hausgeraete GmbH, München (DE)

(72) Inventor: Robert Blaz, Humenne (SK)

(21) Appl. No.: 17/964,223

(22) Filed: Oct. 12, 2022

(30) Foreign Application Priority Data
Oct. 12, 2021 (EP) 21202082.0

(51) Int. Cl. H02K 1/27; H02K 15/03

(52) U.S. Cl. CPC H02K 1/27; H02K 15/03

(57) ABSTRACT

A method for positioning magnets on a rotor of an electric motor includes positioning adjacent magnets in a gap-free circle, and then simultaneously radially moving the magnets until a uniform reference gap is created between them. A device includes a plurality of ring segments capable of forming an adjustable annular ring, being simultaneously moveable in radial direction and being capable of moving the magnets from a gap-free circle radially until a uniform reference gap is created between them. A kitchen appliance is also provided.

### CROSS-REFERENCE TO RELATED APPLICATION

This application claims the priority, under 35 U.S.C. § 119, of European Patent Application EP21202082.0, filed Oct. 12, 2021; the prior application is herewith incorporated by reference in its entirety.

### FIELD AND BACKGROUND OF THE INVENTION

The invention relates to a method for positioning magnets on a rotor of an electric motor, a device for positioning magnets on a rotor of an electric motor and a kitchen appliance.

It has been shown that during assembly of the prior art motor, as shown in FIG. 1 and described below, the position of each magnet can vary slightly. In particular, the circumferential gaps between adjacent magnets can vary which results in cogging torque, noise and vibration generation.

### SUMMARY OF THE INVENTION

It is accordingly an object of the invention to provide a method for positioning magnets on a rotor enabling a precise positioning of the magnets on the rotor, a device for facilitating a precise positioning of magnets on a rotor and a kitchen appliance, which overcome the hereinafore-mentioned disadvantages of the heretofore-known methods, devices and appliances of this general type and which provide an electric motor showing a smooth running behavior.

This object is achieved by a method, a device and a kitchen appliance recited in the independent claims. Advantageous embodiments are disclosed in the dependent claims, the description and the figures.

With the foregoing and other objects in view there is provided, in accordance with the invention, a method for positioning magnets on a rotor of an electric motor, which comprises the following steps:

positioning adjacent magnets in a gap-free circle, and

moving the magnets simultaneously radially until a uniform reference gap is created between them.

Since the magnets are starting at the same point—the gap-fee circle—and are moved simultaneously in radial direction, a precise circumferential and uniform gap can be adjusted between them, independently of their width (circumferential extension of the magnets). Due to the regular distance in circumferential direction between the magnets, cogging torque is avoided which would cause noise and vibration generation. The magnets can be aligned to each other in the rotor without any distance elements. The method can be applied to both types external rotor motor and internal rotor motor. If the method is applied to assembly of an external rotor motor, the magnets are positioned gap free in a radial inner circle and moved radially outwards. If the method is applied to assembly an internal rotor motor, the magnets are positioned gap free in a radial outer circle and moved radially inwards.

The method can be facilitated when the magnets are pre-positioned in a circle having circumferential gaps between them and moved radially to form the gap-free circle. If the method is applied to assembly of an external rotor motor, the magnets are pre-positioned in a radial outer circle and moved radially inwards. If the method is applied to assembly of an internal rotor motor, the magnets are pre-positioned in a radial inner circle and moved radially outwards.

The uniform reference gap is achieved, when the magnets are touching a circumferential surface of a rotor cage. In this way, the surface forms a stop in such a way that the width of the reference gaps is met reliable. If the method is applied to an assembly of an external rotor motor, the surface is an inner circumferential surface of the rotor. If the method is applied to an assembly of an internal rotor motor, the surface is an outer circumferential surface of the rotor.

With the objects of the invention in view, there is also provided a device, comprising a plurality of ring segments capable of forming an adjustable annular ring which are simultaneously moveable in radial direction and capable of moving the magnets from a gap-free circle radially until a uniform reference gap is met between them. Such a device includes only a few elements, which facilitates the positioning of the magnets and its reliability.

In order to enable the magnets to be shifted in a circumferential direction during their radial movements, the ring segments enable a circumferential movement of each magnet.

The ring segments can be moved radially to achieve the gap-fee circle. Therefore, measures are provided to apply a closing force to the segments which is directed radially in the direction of the gap-free circle. If the method is applied to an assembly of an external rotor motor, the closing force is directed radially inwards. If the method is applied to assembly an internal rotor motor, the closing force is directed radially outwards.

Additionally, in order to move the magnets in a counter direction, measures are provided to apply an opening force radially directed away from the gap-free circle. If the method is applied to an assembly of an external rotor motor, the opening force is directed radially outwards. If the method is applied to an assembly of an internal rotor motor, the opening force is directed radially inwards.

With the objects of the invention in view, there is concomitantly provided a kitchen appliance, comprising an electric motor, having a rotor assembled according to the inventive method. A preferred example of a household appliance is a cook hood. Such a kitchen appliance has a smooth running behavior, resulting in a silent operation. Further exemplary appliances are blower NBS EC/EC motors with segment magnets.

Other features which are considered as characteristic for the invention are set forth in the appended claims.

Although the invention is illustrated and described herein as embodied in an assembly method and a device for a rotor of an electric motor, and a kitchen appliance, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a diagrammatic, perspective view of a rotor of an electric motor according to the prior art;

FIG. 2 is a perspective view of a rotor according to the invention; and

FIG. 3 is a plan view illustrating assembly steps of the rotor according to the invention.

### DETAILED DESCRIPTION OF THE INVENTION

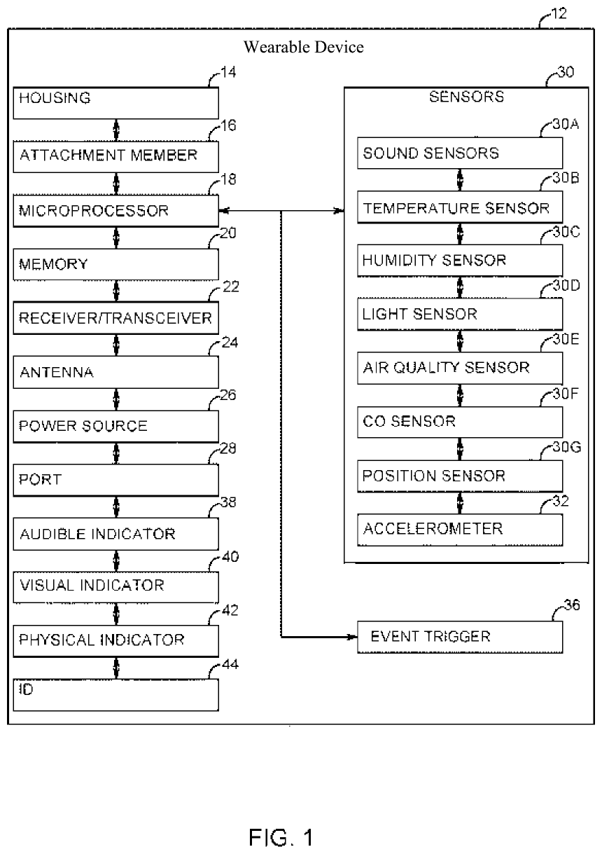

Referring now to the figures of the drawings in detail and first, particularly, to FIG. 1 thereof, there is seen a prior art rotor 1 of an electric motor. The motor is configured as an external rotor motor. The rotor 1 has a cage 2 rotating on a rotation axis 4 around an inner stator (not shown) and carries a plurality of permanent magnets 6 on its inner circumferential surface. The inner stator is equipped with electric coils and is non-rotatable. Spring sheets 8 are positioned in circumferential gaps 10 between the magnets 6 in order to keep the magnets at a distance from each other.

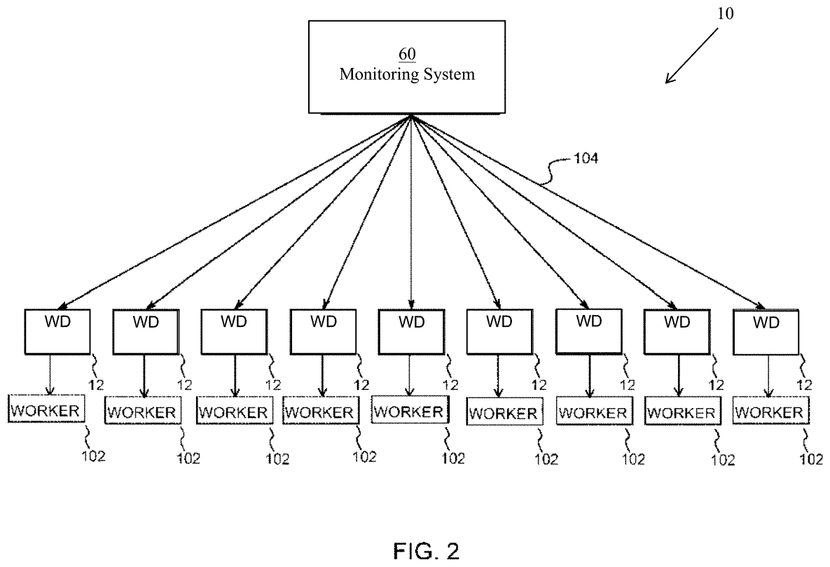

FIG. 2 shows a preferred embodiment of a rotor 12 of an electric motor. In the following, any direction term such as circumferential refers to a rotation axis 16 of the rotor 12. The motor is configured as an external rotor motor. The rotor 12 has a cage 14 rotating on the rotation axis 16 around an inner stator (not shown) and carries a plurality of segmented magnets 18, in particular arc-shaped permanent magnets, on its inner circumferential surface 20. The non-illustrated inner stator is equipped with electric coils and is non-rotatable. The magnets 18 are held in place on the circumferential surface 20 by glue, for instance. A circumferential gap 22 is shown between two adjacent magnets 18a, 18b. The gaps 22 extents in axial direction and has a uniform extension in circumferential direction (width).

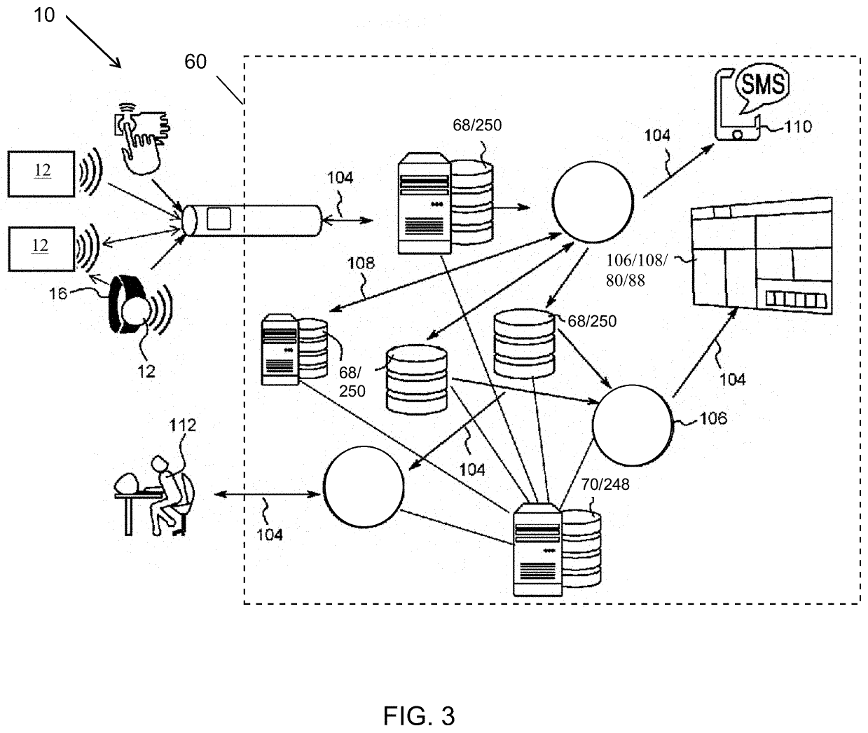

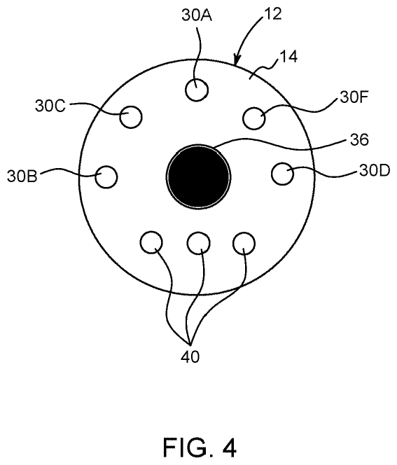

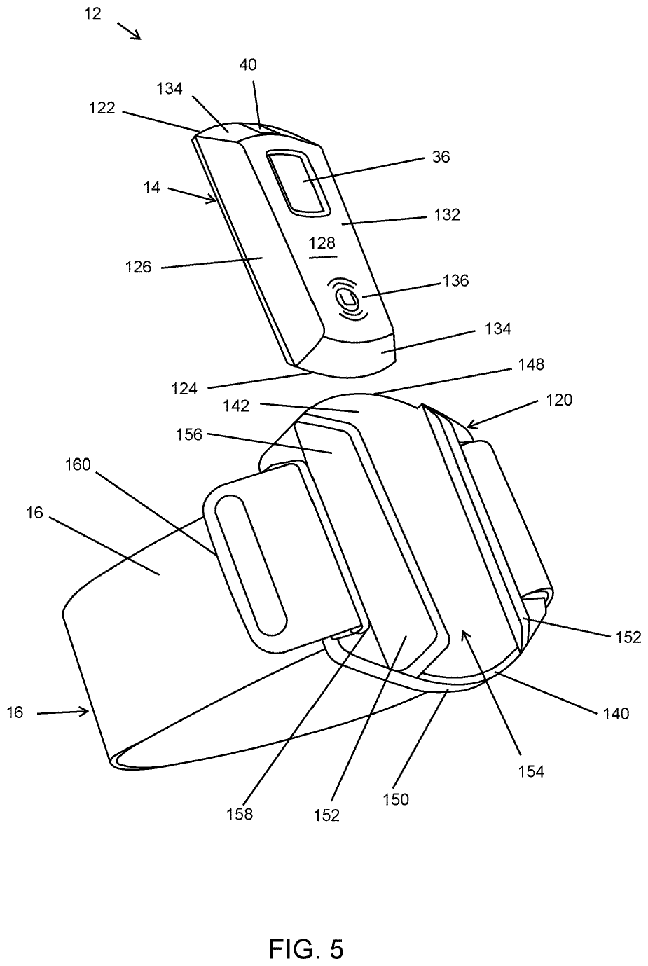

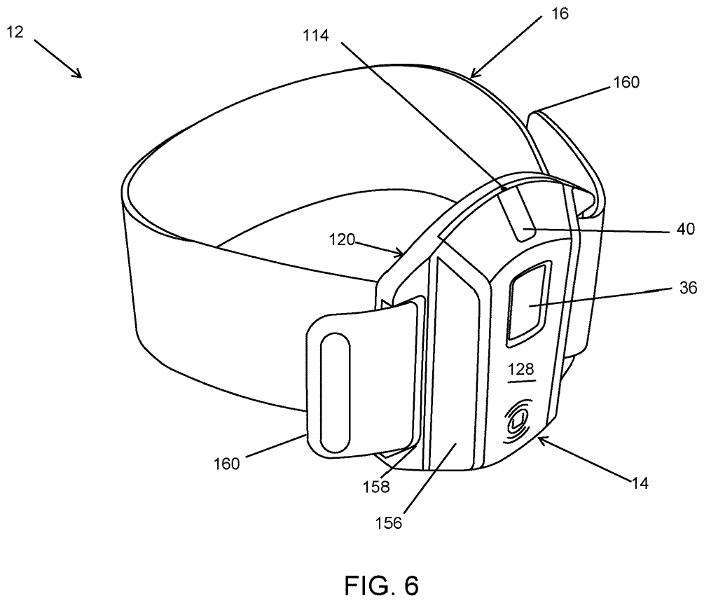

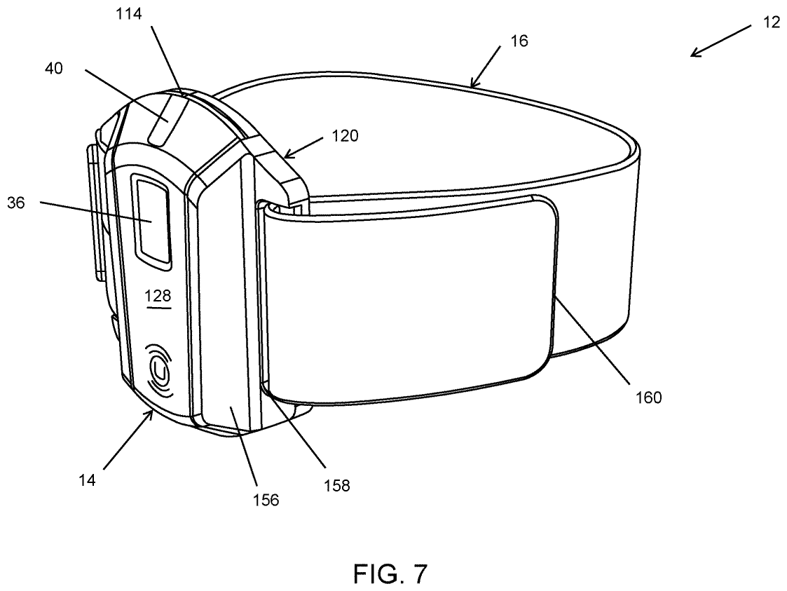

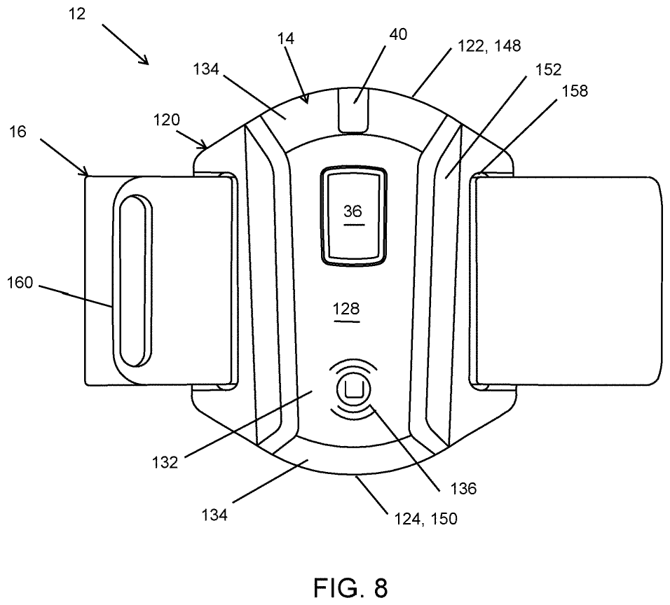

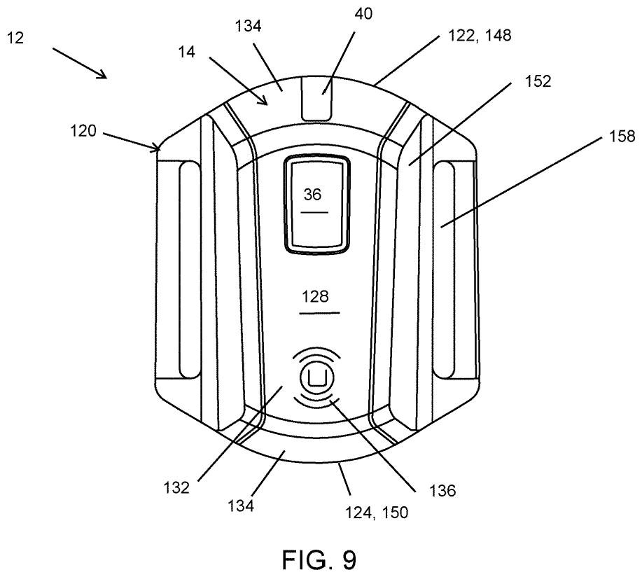

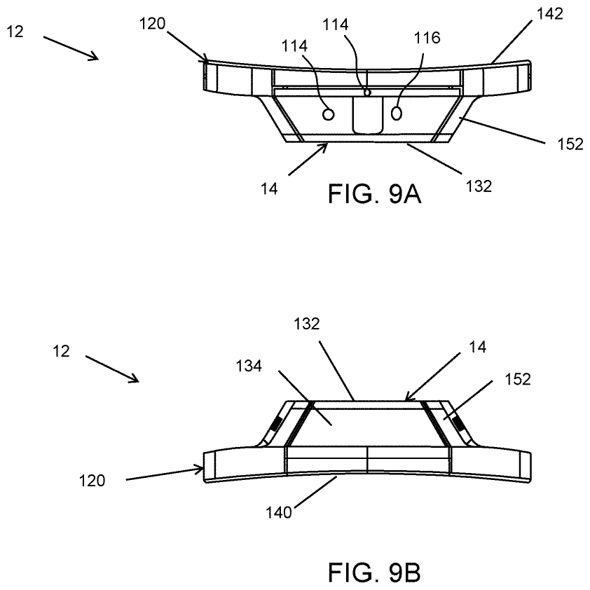

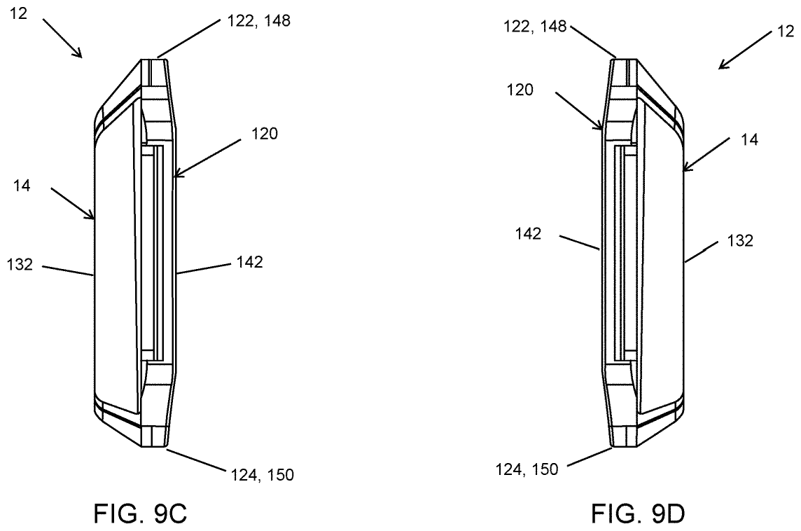

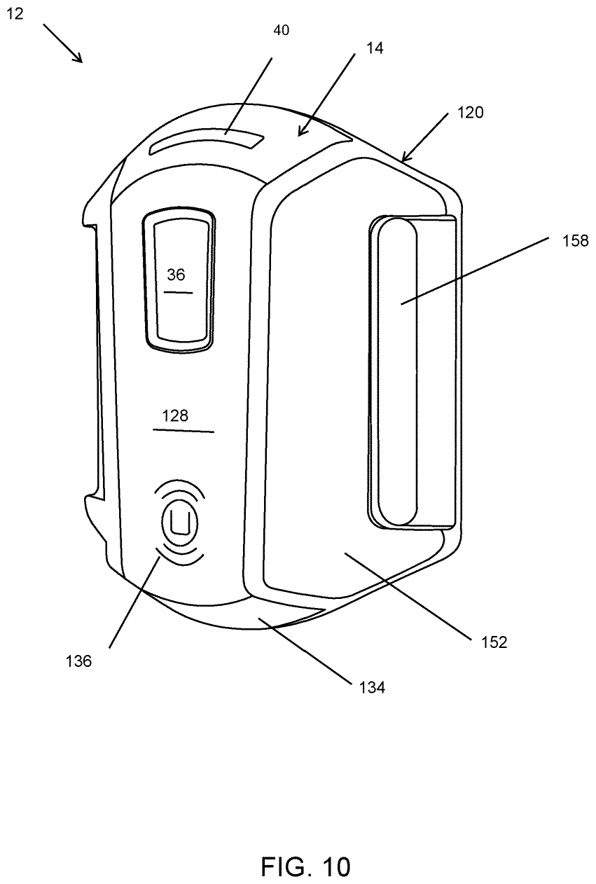

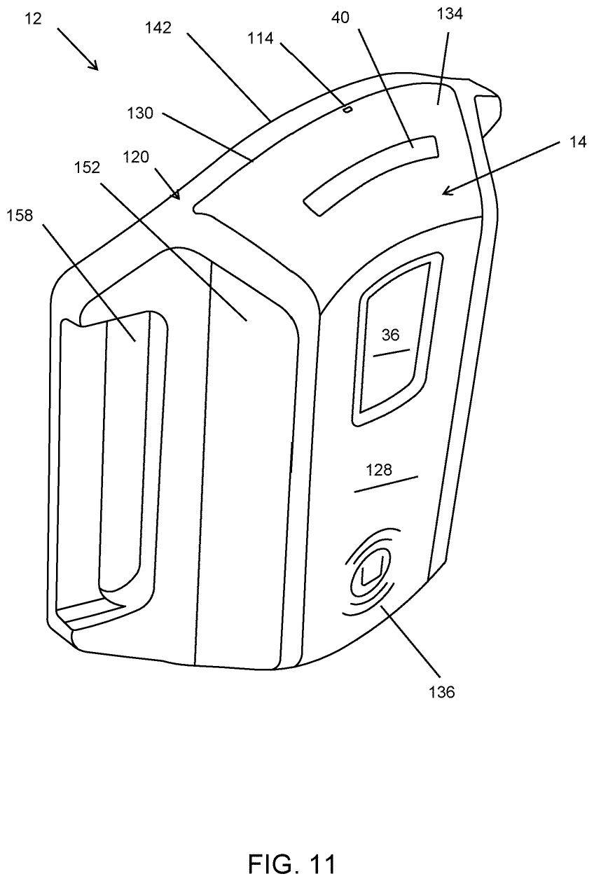

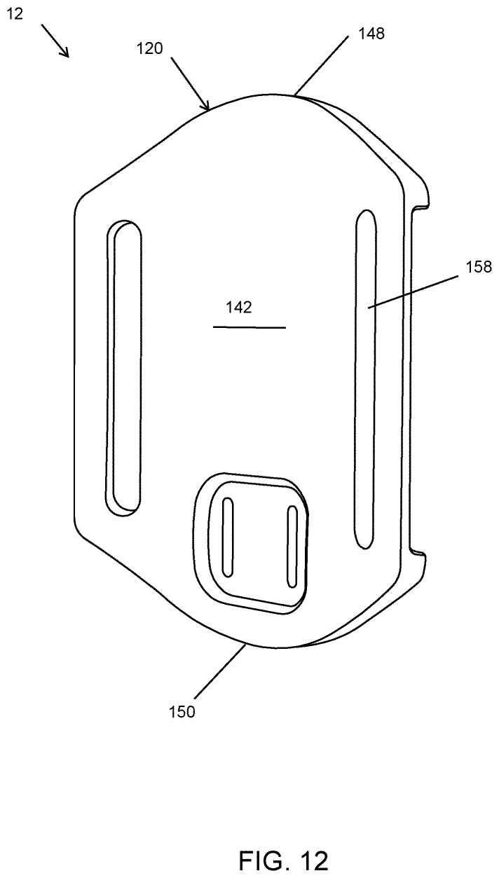

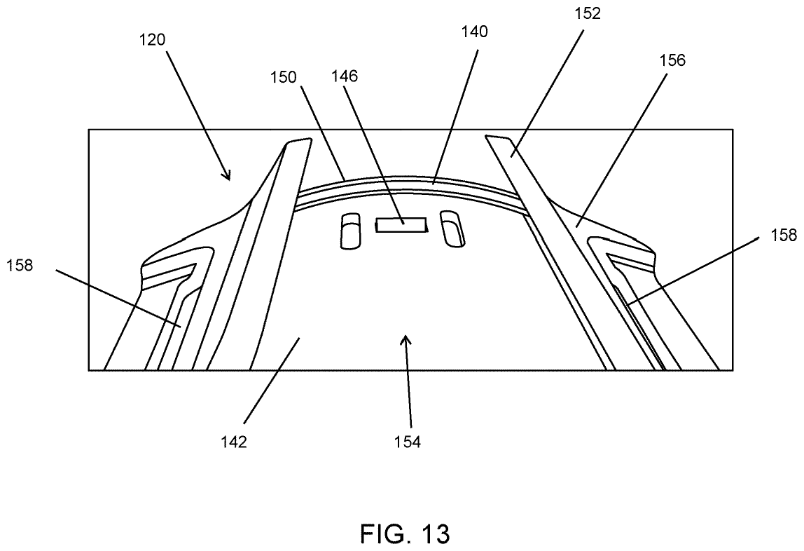

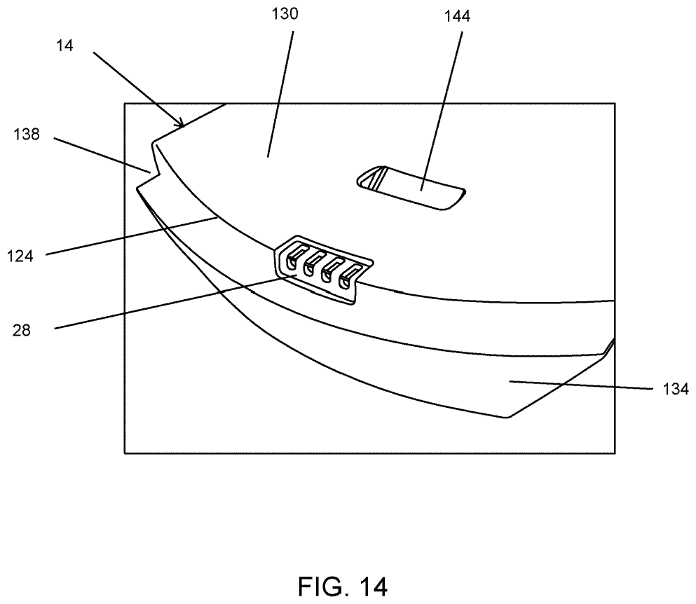

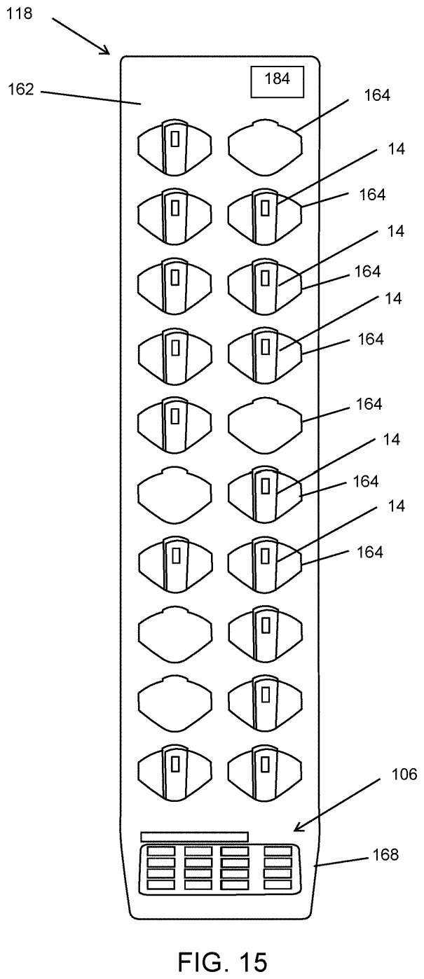

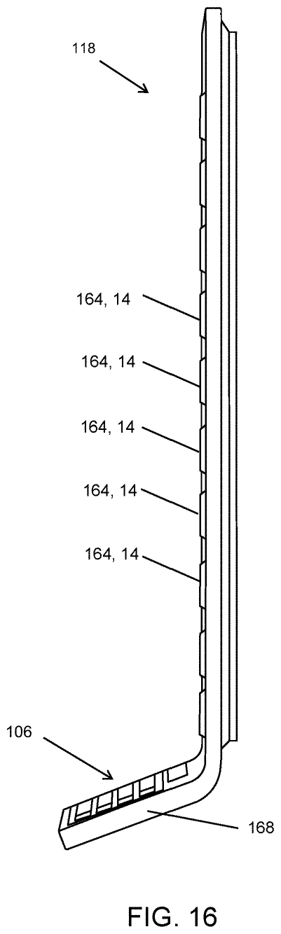

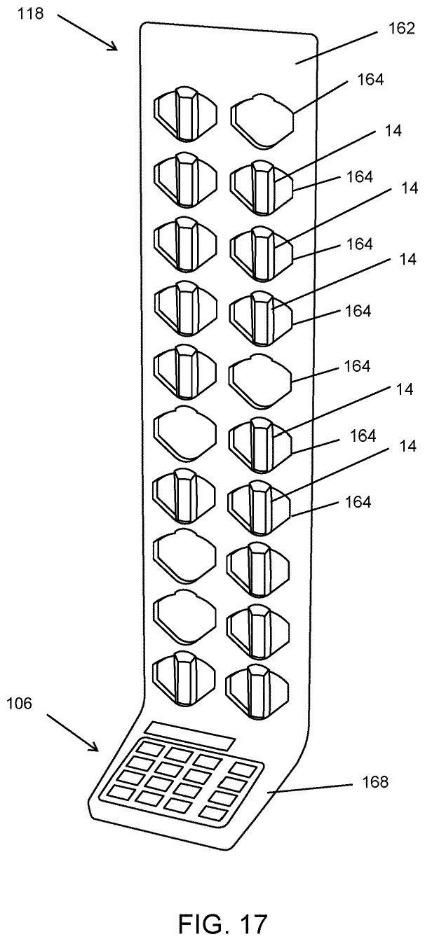

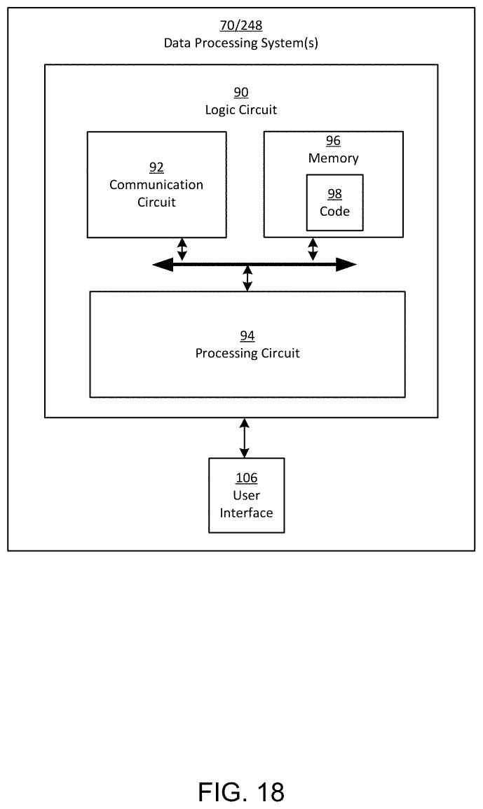

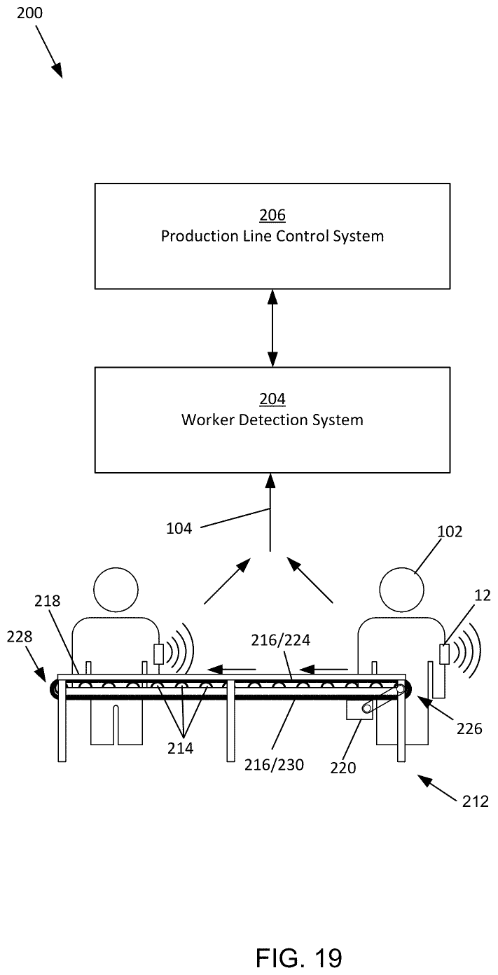

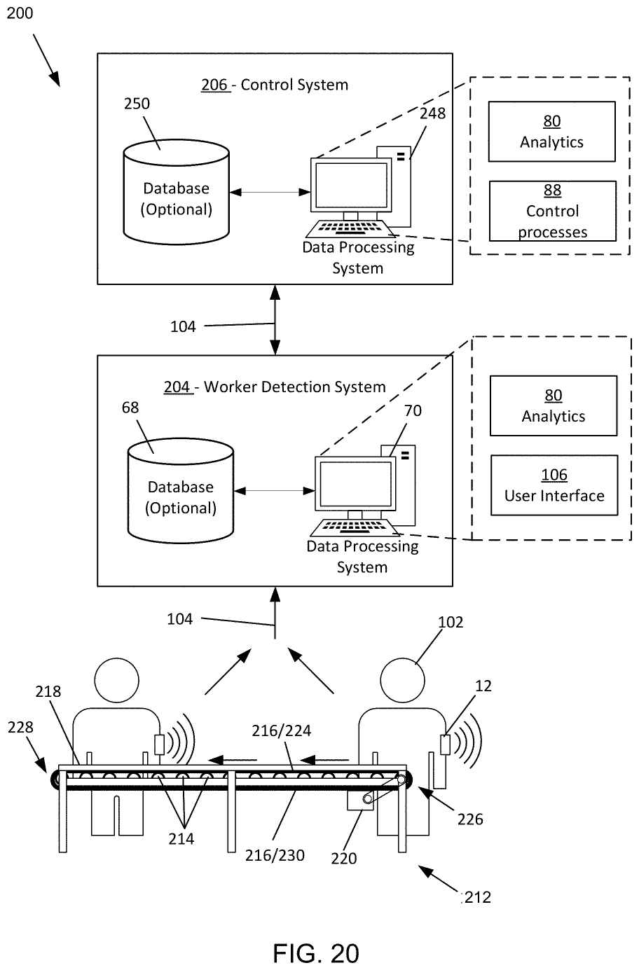

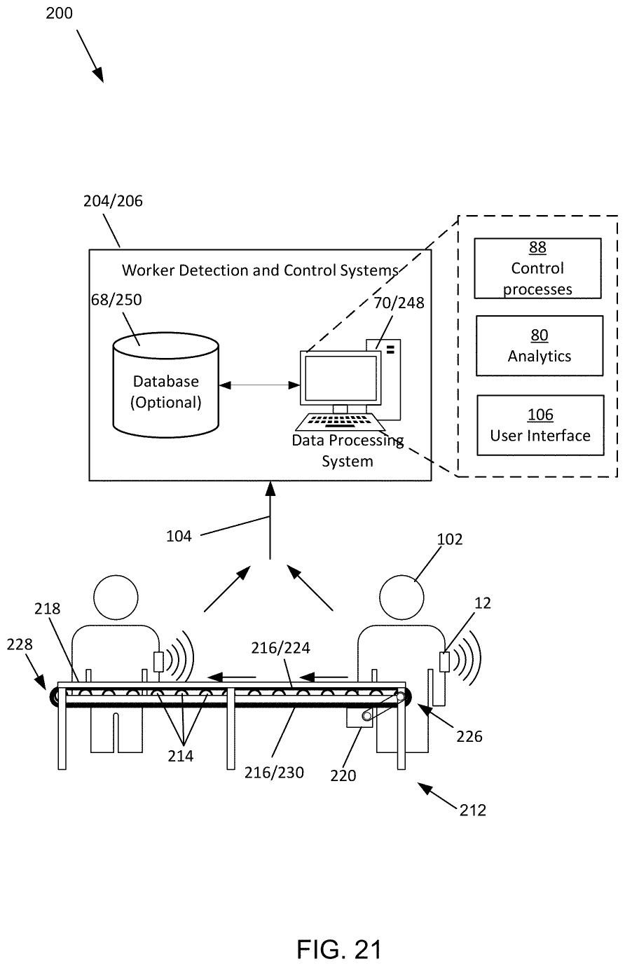

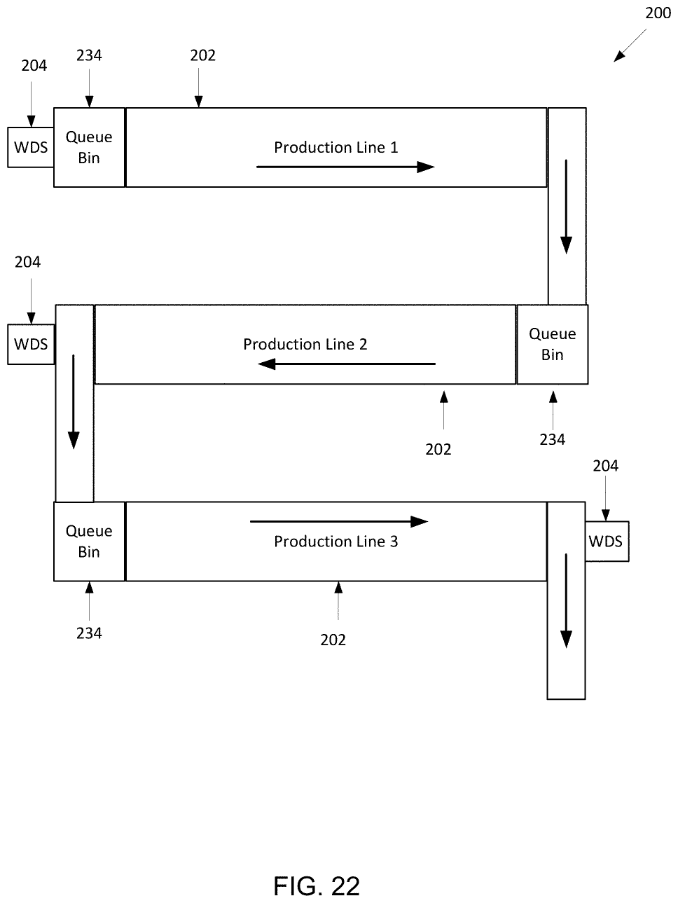

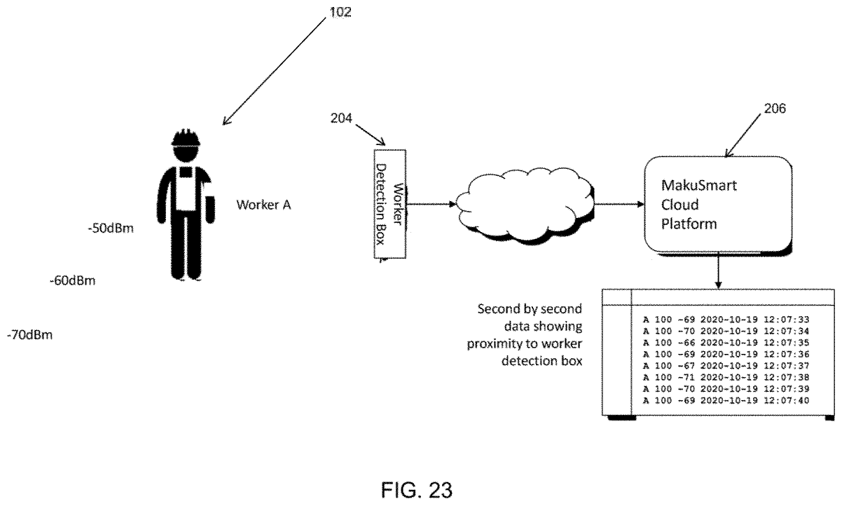

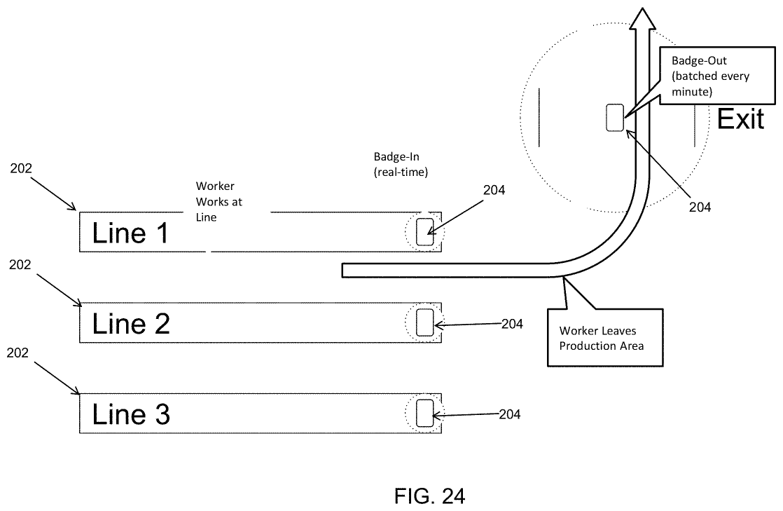

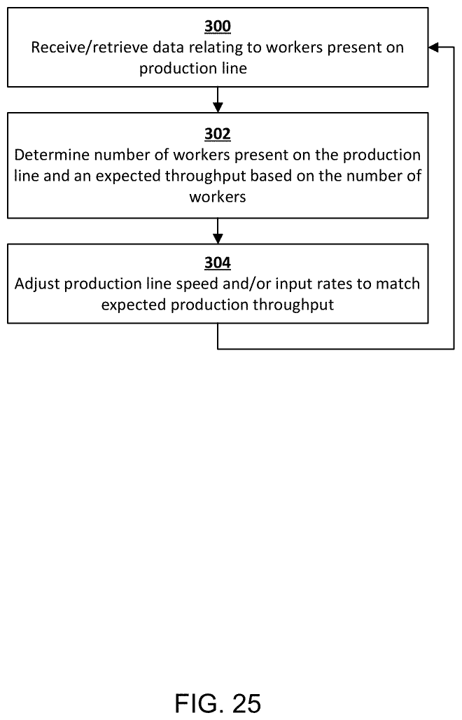

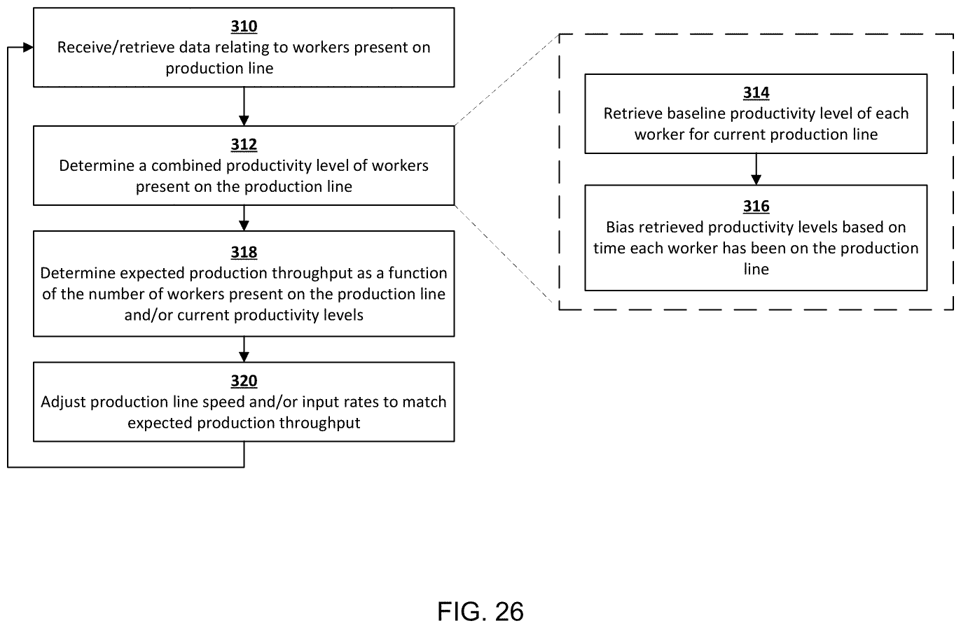

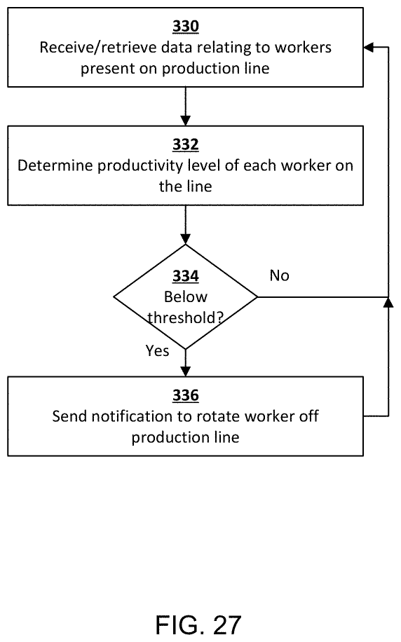

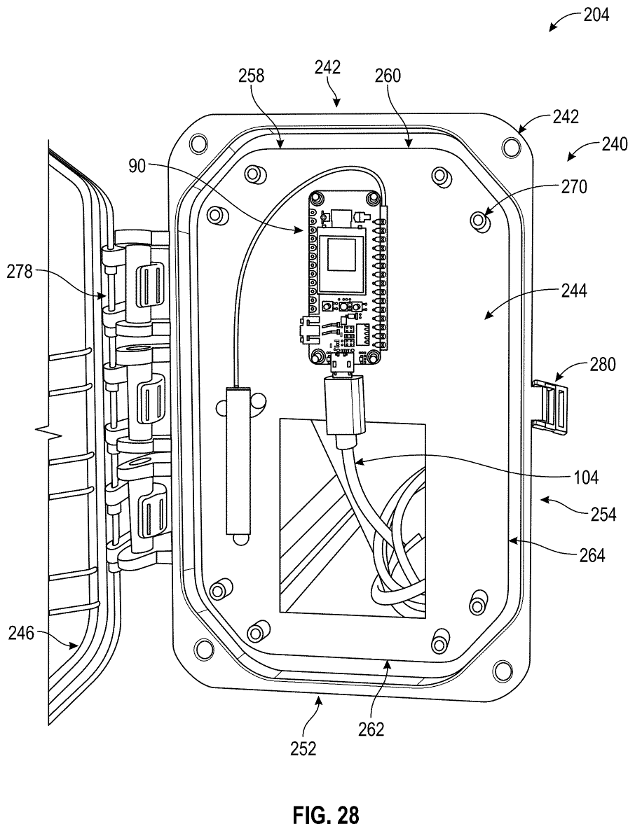

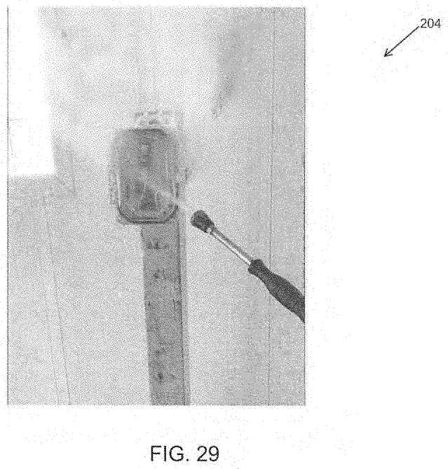

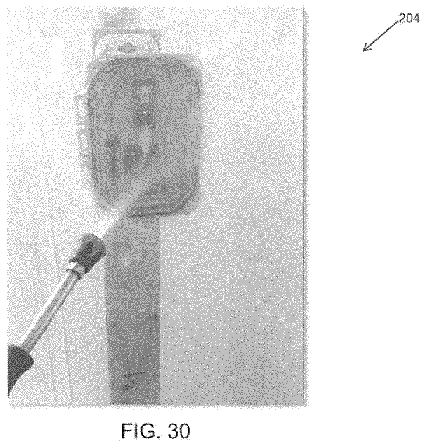

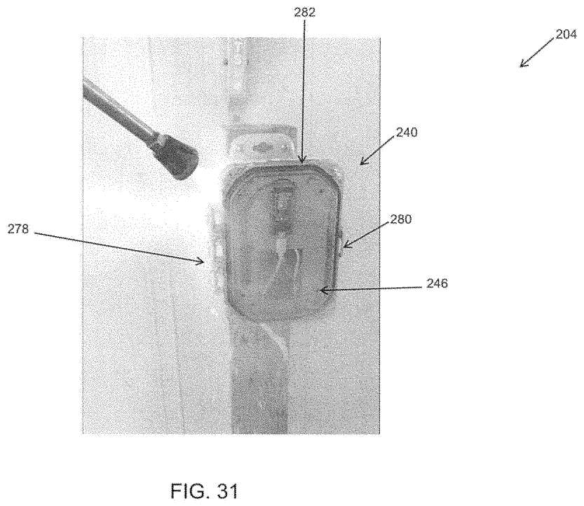

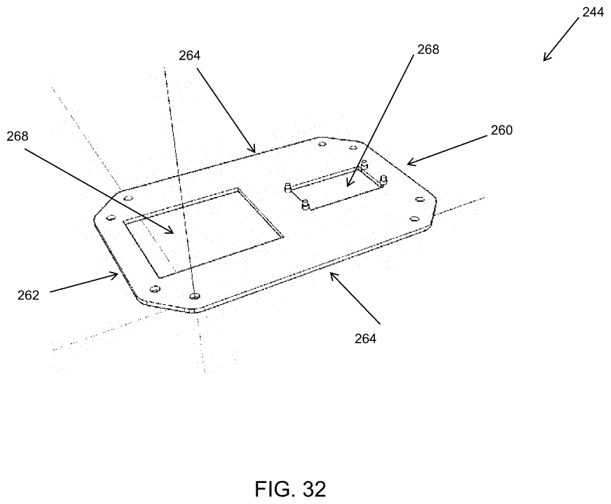

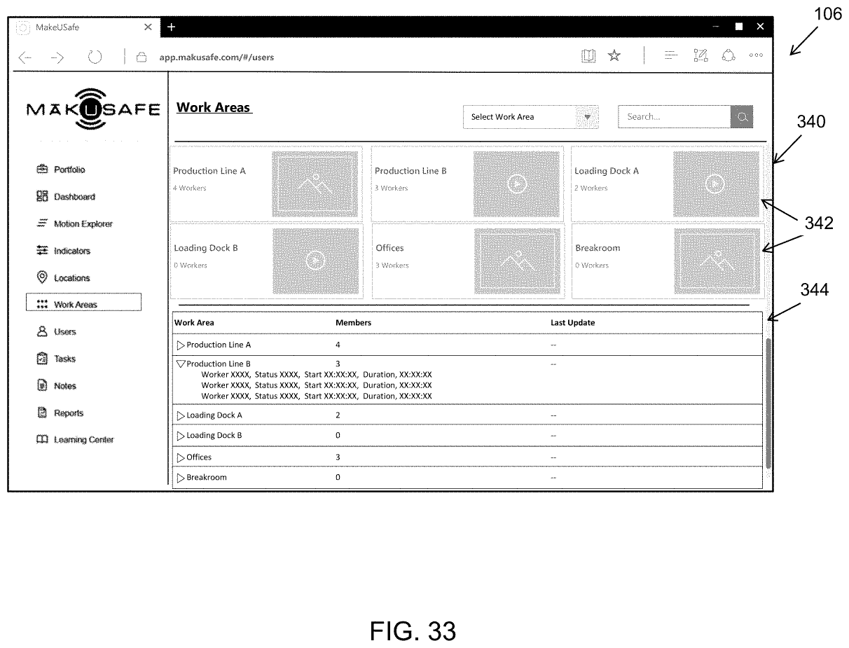

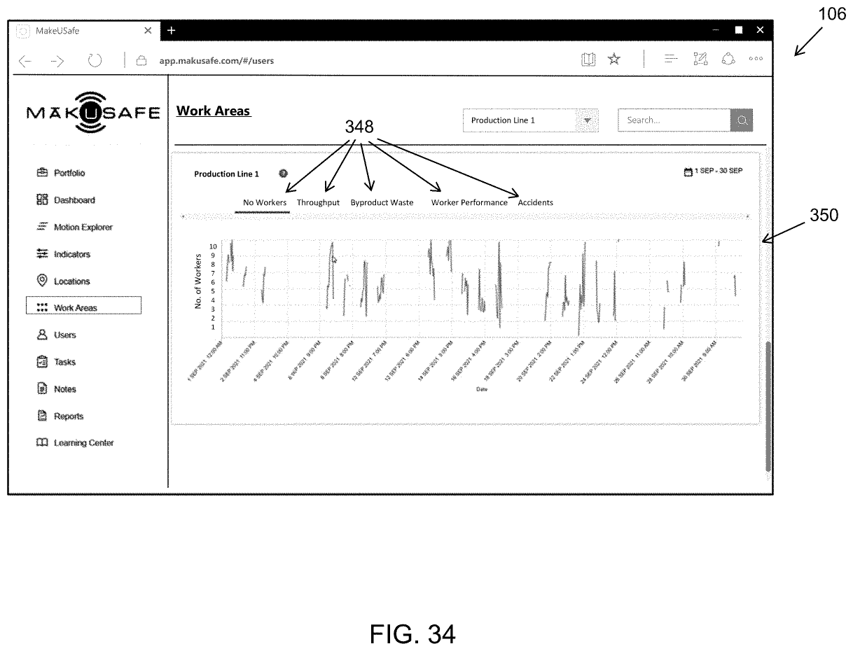

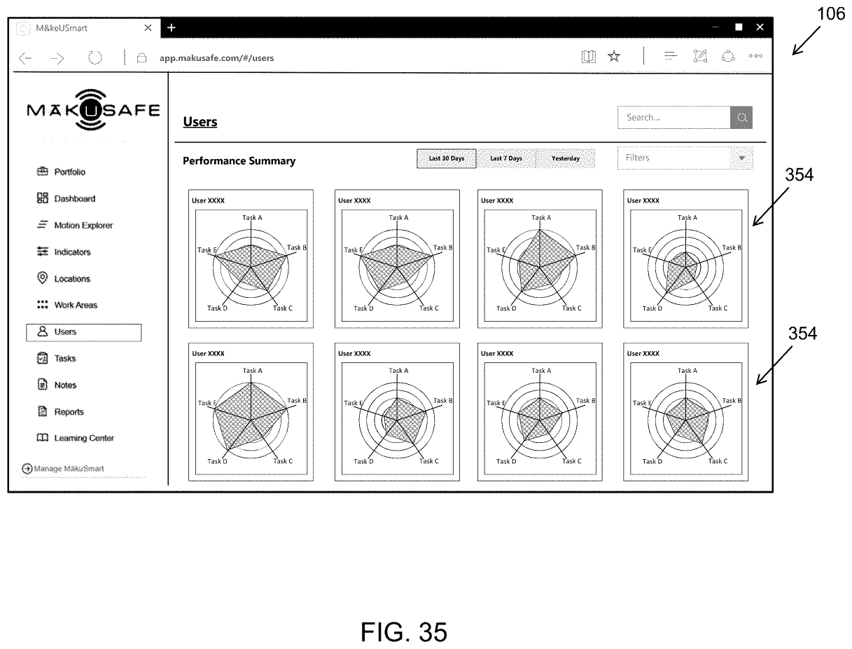

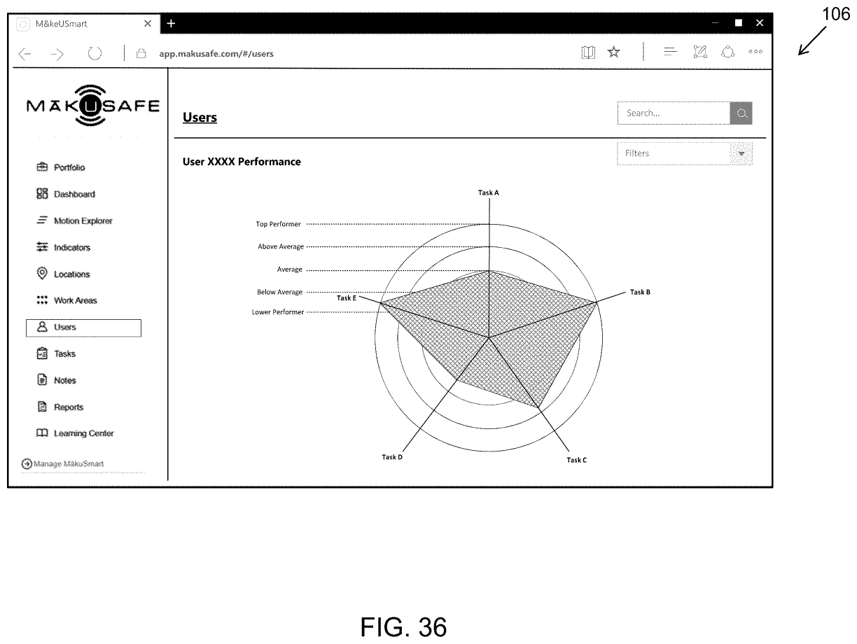

As is illustrated in FIG. 3, the magnets 18 are positioned on the rotor 12 with the uniform reference gap 22 between them as follows:
In a first step, the magnets 18 are positioned in a radial outer circle (not shown) having random gaps between them.
In a second step, the magnets 18 are moved radially inwards until they are positioned in a gap-free circle (not shown).
In a third step, the magnets 18 are moved simultaneously radially outwards until the uniform reference gap 22 is met between them. In this state, when the uniform reference gap 22 is achieved between all adjacent magnets 18, the magnets 18 are touching a circumferential surface 20 of the rotor cage 14 with their rear surface which facilitates the fixation of the magnets 18 to the inner circumferential surface 20 (see the fourth step).
In a fourth step, the magnets 18 are fixed to the inner circumferential surface 20 of the rotor 12.

In order to move the magnets adequately, a plurality of triangle-shaped ring segments 24 are provided. As shown, the ring segments 24 form an annular ring that can be maximized or minimized by, preferrable simultaneous, radial movement of them. The magnets 18 can be fixed to the segments 24 or the magnets can be positioned radially outside of the segments 24 but in surface contact with them. The segments 24 are movable in both radial directions 26, 28 by applying a radial closing force 30 to the magnets or by applying a radial opening force 32 to the segments 24 in counter direction. In addition, the magnets 18 are movable in circumferential direction 34 when being in circumferential surface contact with the segments 24 or when fixed on the segments 24.

In a fifth step, the segments 24 and an inventive device respectively providing the segments 24 are removed after the attachment of the magnets 18 to the rotor 12.

The closing force 30 and the opening force 32 are applied by respective devices, which are also part of the device according to the invention and are not shown.

In FIG. 3, the width of the magnets 18 varies. The magnets 18 are shown with different widths only in order to illustrate that the method according to the invention is applicable independently of their extensions in circumferential direction. For the sake of a smooth running, magnets having the same width are preferred.

Although the method is explained with reference to an external rotor motor, the method of the invention can also be applied to an internal rotor motor by changing the radial movements in counter directions and by positioning the magnets 18 within the ring built by the segments 24. If the rotor 12 is part of an internal rotor motor, an additional fixture can be provided to keep the magnets 18 in position before fixing them to an outer circumferential rotor surface.

Disclosed are a method for positioning magnets 18 on a rotor of an electric motor, wherein adjacent magnets 18 are positioned in a gap-free circle, and then moved simultaneously radially until a uniform reference gap 22 is met between them, a device having a plurality of ring segments 24 capable of forming an adjustable annular ring which are simultaneously moveable in radial direction and capable of moving the magnets 18 from a gap-free circle radially until a uniform reference gap 22 is met between them, and a kitchen appliance.

The following is a summary list of reference numerals and the corresponding structure used in the above description of the invention.

### REFERENCE LIST

1 rotor

2 cage

4 rotation axis

6 magnet

8 spring sheet

10 circumferential gap

12 rotor

14 cage

16 rotation axis

18, 18a, 18b magnet

20 inner circumferential surface

22 gap

24 ring segment

26 radial direction of the segments

28 radial direction of the segments

30 closing force

32 opening force

34 circumferential direction

1. A method for positioning magnets on a rotor of an electric motor, the method comprising:
positioning adjacent magnets in a gap-free circle; and
moving the magnets simultaneously radially until uniform reference gaps are created between the magnets.

2. The method according to claim 1, which further comprises pre-positioning the magnets in a circle having circumferential gaps and moving the magnets radially to form the gap-free circle.

3. The method according to claim 1, which further comprises touching the magnets against a circumferential surface of a rotor cage when the uniform reference gaps are achieved.

4. A device for positioning magnets on a rotor of an electric motor, the device comprising:
a plurality of ring segments capable of forming an adjustable annular ring;
said plurality of ring segments being simultaneously moveable in radial direction; and
said plurality of ring segments being capable of moving the magnets radially from a gap-free circle until creating uniform reference gaps between the magnets.

5. The device according to claim 4, wherein said ring segments enable a circumferential movement of each magnet.

6. The device according to claims 4, which further comprises a device for applying a closing force to said plurality of ring segments, said closing force being directed radially in a direction of said gap-fee circle.

7. The device according to claims 6, which further comprises a device for applying an opening force to the magnets, said opening force being directed radially away from said gap-free circle.

8. A kitchen appliance, comprising:
an electric motor having a rotor; and
adjacent magnets simultaneously radially movable from a gap-free circle until being positioned on said rotor with uniform reference gaps between said magnets.

9. The kitchen appliance according to claim 8, wherein said electric motor is a cook hood motor.
